(19) United States
(12) Patent Application Publication
(10) Pub. No.: US 2019/0022991 A1
(43) Pub. Date: Jan. 24, 2019

(54) METHOD FOR SHAPING FRAME STRUCTURE USING MULTILAYER BOARD

(71) Applicant: Fujian Shuangyi Bamboo and Wood Development Co., Ltd., Nanping (CN)

(72) Inventor: ZHISHENG LI, NANPING (CN)

(21) Appl. No.: 15/693,126

(22) Filed: Aug. 31, 2017

(30) Foreign Application Priority Data
Jul. 22, 2017 (CN) 201710603139.9

(51) Int. Cl. B32B 37/12; B27M 1/08; B27M 3/00; B27M 3/34; B32B 38/00

(52) U.S. Cl. CPC B32B 37/12; B27M 1/08; B32B 38/0004; B27M 3/34; B27M 3/0086

(57) ABSTRACT

The present invention relates to a method for shaping a frame structure using a multilayer board to solve the technical problem of low production efficiency of the existing bamboo frame structure. The present invention has the first solution of bending a multilayer board into a profiled board using the board bending technology; cutting the profiled board into several framing units; and finally connecting end portions of one, two or plural framing units one another, thereby forming a frame structure. The present invention has the second solution of gluing and stacking a plurality of single boards and laminating them into a profiled board; cutting the profiled board into several framing units; and finally connecting end portions of one, two or plural framing units one another, thereby forming a frame structure.

### CROSS-REFERENCE TO RELATED APPLICATIONS

This application claims priority to Chinese Patent Application No. 201710603139.9 with a filing date of Jul. 22, 2017. The content of the aforementioned applications, including any intervening amendments thereto, are incorporated herein by reference.

### TECHNICAL FIELD

The present invention relates to a field of processing technologies for bamboo materials, and in particular, to a method for shaping a frame structure using a multilayer board.

### BACKGROUND OF THE PRESENT INVENTION

The Chinese patent discloses a bamboo frame shaping process (No. 2015108717290), including the following steps: heating a fixed die and a movable die to an appropriate temperature; preparing bamboo strips; arranging bamboo strips; disposing the bamboo strips and assembling the dies; shaping; and demoulding. This technology solves the technical problems that the existing bamboo frame is manually weaved, the bamboo material needs to be cut into relatively thin flat bamboo strips, the processing is inconvenient and the working efficiency is low. Moreover, this technology has the following defects.

1. To produce each bamboo frame, a series of process flows of preparing bamboo strips, arranging bamboo strips, disposing the bamboo strips and assembling the dies, shaping and demoulding is necessary, which cannot effectively increase the production efficiency of the bamboo frame.

2. In the process of arranging and disposing the bamboo strips and assembling the dies, the displacement tends to occur between adjacent inner and outer bamboo strips, an alignment error is large in two end portions of the bamboo strips, a defective rate is high, and the product quality cannot be effectively controlled.

3. The bamboo strip is heated and softened by heat transfer among the fixed die, the movable die and the bamboo strip. When the bamboo frame to be shaped has a relatively thick cross section, uneven heating tends to occur, particularly a rebounding stress of the bamboo strip at the center of the cross section of the bamboo frame cannot be effectively eliminated.

### SUMMARY OF PRESENT INVENTION

Based on the above defects in the prior art, the present invention provides a method for shaping a frame structure using a multilayer board. This method can effectively shorten working hours for the bamboo frame structure, and increase the production efficiency and product quality.

The present invention has the first technical solution as follows. A method for shaping a frame structure using a multilayer board includes the steps of bending a multilayer board into a profiled board using the board bending technology, cutting the profiled board into several framing units, and finally connecting end portions of one, two or plural framing units one another, thereby forming a frame structure. The method specifically includes the following steps.

S1: bending the multilayer board to form a profiled board.

The multilayer board commercially available or one produced before the step S1 is used. The process for manufacturing a multilayer board includes: coating glue on a plurality of single boards, and then stacking the plurality of glued single boards, and putting them in a hot-embossing machine to manufacture a multilayer flat board.

The multilayer board includes a multilayer bamboo board, a multilayer wood board, or the like. Prior to bending, it needs to microwave heat and soften the multilayer board, to prevent the board from cracking during bending. The multilayer board is bent step by step, to avoid surface cracking caused by short-time bending.

S2: processing a connecting groove on the profiled board.

The connecting portions at the two ends of the profiled board can be slotted by a slot milling machine at the same time.

S3: cutting the profiled board into several framing units.

Usually, the profiled board is cut uniformly in a direction of a symmetric axis of the profiled board by a multiple blade saw.

S4: connecting the end portions of one, two or plural framing units one another, thereby forming a frame structure. The final finished product is formed by grinding, polishing and painting the formed frame structure.

When the profiled board is cylindrical, a single framing unit after cutting can enclose one annular structure by itself. Thus, a frame structure may be formed only by connecting a head end portion and a tail end portion of this framing unit. The cross section of the cylindrical body may be circular, elliptical, triangular, rectangular or polygonal, or profiled.

When the profiled board is semi-cylindrical, the two cut framing units may be butt-jointed to enclose an annular structure. Thus, a frame structure may be formed by connecting in series the end portions of these two framing units.

When the profiled board has a radian or an included angle, the plural cut framing units may be butt-jointed successively to enclose an annular structure. Thus, a frame structure may be formed by connecting in series the end portions of plural framing units.

The first technical solution of the present invention improves the production efficiency mainly by the following facts.

(1) In the multilayer board making stage, the multilayer board is shaped rapidly according to the existing process. Due to mature production process of the multilayer board, its production efficiency is relatively high. Compared with the prior art in which the production of each framework needs the processes of arranging and placing the bamboo strips, the working hours may be shortened greatly.

(2) In the bending and shaping stages, the entire board is bent to be shaped, which corresponds to bend and shape the plurality of framing units. Compared with the prior art in which each framework unit needs to be bent and shaped, the present invention saves much working hours.

(3) In the stage of shaping a connecting groove, prior to cutting, the connecting groove is processed at the two ends of the profiled board, which corresponds to process the connecting groove at the two ends of the plurality of framing units at the same time. On the one hand, the working hours can be shortened effectively, and the efficiency is increased. On the other hand, the standardized production can be realized, and the working accuracy of the connecting groove is increased. The present invention solves the problem of machining error in manual arrangement and disposition of the bamboo strips in the prior art.

(4) In the stage of cutting the profiled board, the multiple blade saw is used to cut the profiled board into several framing units at a time, with high efficiency and high quality.

(5) In the stage of bending the multilayer board into the profiled board, the bamboo board is microwave heated and softened, such that the multilayer board is entirely heated uniformly, which contributes to the elimination of a rebounding stress.

The present invention has the second technical solution as follows. A method for shaping a frame structure using a multilayer board includes the steps of gluing and stacking a plurality of single boards and laminating them into a profiled board, i.e. making a profiled board by the plurality of single boards directly; cutting the profiled board into several framing units, and finally connecting end portions of one, two or plural framing units one another, thereby forming a frame structure. The method specifically includes the following steps.

S1: gluing and successively stacking the plurality of single boards to form a multiplayer superposed board; bending and shaping the multiplayer superposed board on a special shape forming machine to make into a profiled board; the special shape forming machine is provided with a microwave heating device to heat the plurality of single boards uniformly.

S2: processing a connecting groove on the profiled board.

S3: cutting the profiled board into several framing units.

S4: connecting the end portions of one, two or plural framing units one another, thereby forming a frame structure. The final finished product is formed by grinding, polishing and painting the formed frame structure.

The second technical solution of the present invention mainly improves the step S1 in the first technical solution and has same other steps as the second technical solution.

Compared with the first technical solution according to the present invention, the second technical solution improves the production efficiency mainly by gluing and stacking the plurality of single boards and directly laminating into the profiled board in the stage of shaping the profiled board, such that the shaping process of the profiled board is further simplified, which not only effectively shortens the production time of the profiled board, but also reduces the shaping difficulty of the profiled board, and avoids the problem of cracking at a corner in the case that the multilayer board is bent into the profiled board.

### DESCRIPTION OF THE DRAWINGS

FIG. 1 is a schematic diagram showing the process for shaping a frame structure using a three-layer board in the first embodiment.

FIG. 2 is a schematic diagram showing the process for shaping a frame structure using three single boards in the second embodiment.

Reference numerals: 1—three-layer board, 2—U-shaped board, 3—connecting groove, 4—framing unit, 4′—framing unit, 5—frame structure, 6—single board, 7—three-layer superposed board.

### DETAILED DESCRIPTION OF PREFERRED EMBODIMENTS

In order to explain the technical contents, the object and effects to be realized of the present invention in detail, the present invention will be explained further in detail in combination with the embodiments and drawings.

### First Embodiment

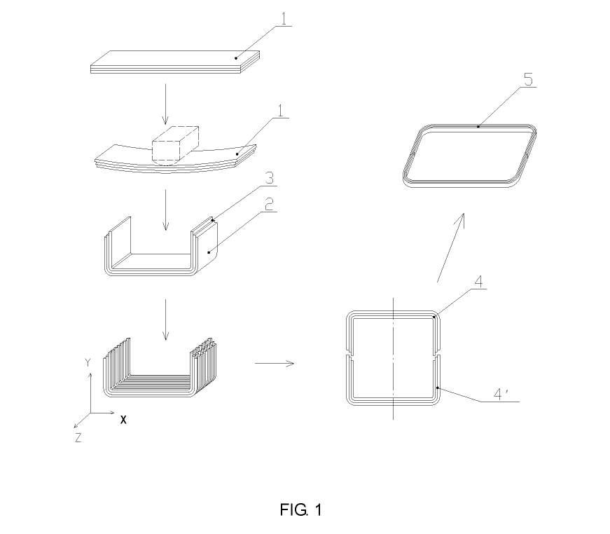

As shown in FIG. 1, a three-layer board is taken as an example in FIG. 1.

A method for shaping a frame structure using a three-layer board includes the following steps of:

S1: bending a three-layer board 1 to form a U-shaped board 2.

The three-layer board 1 commercially available or the one manufactured by coating glue on three single boards, and then stacking the glued three single boards, and putting them in a hot-embossing machine. The single board is a bamboo or wood single board.

Prior to bending, it needs to microwave heat and soften the three-layer board 1. The three-layer board is bent step by step, to avoid cracking during bending.

S2: processing a connecting groove 3 at two ends of the U-shaped board 2.

Usually, connecting portions at the two ends of the U-shaped board 2 can be slotted by a slot milling machine at the same time, to form a connecting groove 3.

S3: cutting the U-shaped board 2 into several framing units 5.

The U-shaped board 2 is cut uniformly in a direction of a Z axis of the U-shaped board 2 by a multiple blade saw.

S4: connecting the end portions of two framing units 5 one another, thereby forming a frame structure. The final finished product is formed by grinding, polishing and painting the formed frame structure 5.

### Second Embodiment

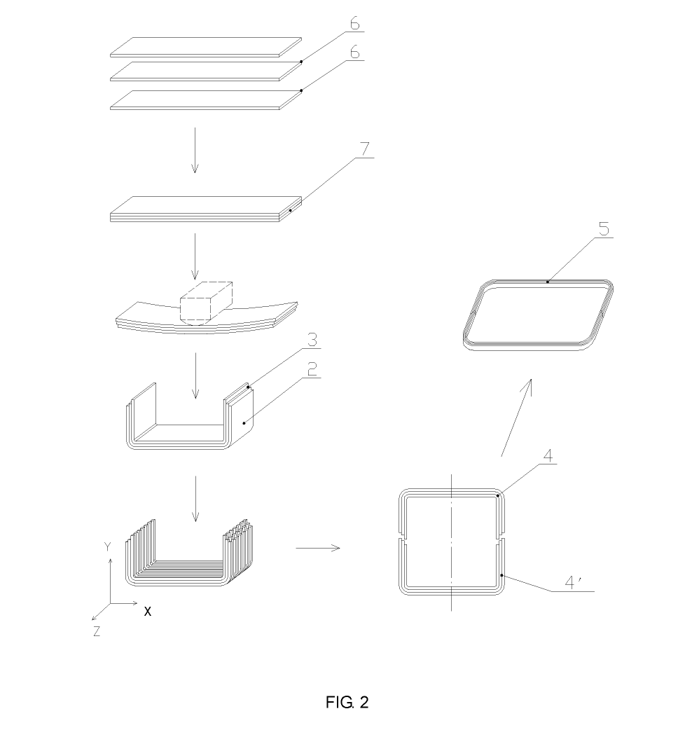

As shown in FIG. 2, three single boards are taken as an example in FIG. 2.

A method for shaping a frame structure using three single boards 6 includes the following steps of:

S1: gluing and successively stacking three single boards to form a three-layer superposed board 7 just in a superposed state without glue; bending and shaping the three-layer superposed board 7 on a special shape forming machine to make into a U-shaped board 2; the special shape forming machine is provided with a microwave heating device to entirely heat the three-layer superposed board uniformly.

S2: processing a connecting groove 3 at the two ends of the U-shaped board.

Connecting portions at the two ends of the profiled board can be slotted by a slot milling machine at the same time.

S3: cutting the U-shaped board 2 into several framing units 5.

The U-shaped board 2 is cut uniformly in a direction of a Z axis of the profiled board by a multiple blade saw.

S4: connecting the end portions of two framing units 5 one another, thereby forming a frame structure. The final finished product is formed by grinding, polishing and painting the formed frame structure 5.

The foregoing description only shows preferable embodiments of the present invention, and does not intend to limit the patent scope of the present invention. Equivalent structures or equivalent flows made in accordance with the specification and drawings of the present invention may be applied in other related arts directly or indirectly, and fall within the protection scope of the present invention.

I claim:

1. A method for shaping a frame structure using a multilayer board, comprising the steps of bending a multilayer board into a profiled board; cutting the profiled board into several framing units; and finally connecting end portions of one, two or plural framing units one another, thereby forming a frame structure.

2. The method for shaping a frame structure using a multilayer board according to claim 1, comprising:
S1: bending the multilayer board to form a profiled board;
S2: processing a connecting groove on the profiled board;
S3: cutting the profiled board into several framing units;
S4: connecting the end portions of one, two or plural framing units one another, thereby forming a frame structure.

3. A method for shaping a frame structure using a multilayer board, comprising the steps of gluing and stacking a plurality of single boards and laminating them into a profiled board; cutting the profiled board into several framing units; and finally connecting end portions of one, two or plural framing units one another, thereby forming a frame structure.

4. The method for shaping a frame structure using a multilayer board according to claim 3, comprising.
S1: bending and shaping a plurality of single boards on a special shape forming machine to make into a profiled board;
S2: processing a connecting groove on the profiled board;
S3: cutting the profiled board into several framing units;
S4: connecting the end portions of one, two or plural framing units one another, thereby forming a frame structure.

5. The method for shaping a frame structure using a multilayer board according to claim 3, wherein the single board is a bamboo or wood single board.
